(19) United States
(12) Patent Application Publication
(10) Pub. No.: US 2026/0259069 A1
(43) Pub. Date: Sep. 3, 2026

(54) DATA INTEGRATION DEVICE, DATA INTEGRATION METHOD, AND NON-TRANSITORY COMPUTER-READABLE MEDIUM

(71) Applicant: NEC Corporation, Tokyo (JP)

(72) Inventors: Daisuke IKEFUJI, Tokyo (JP); Hemant Shivsagar Prasad, Tokyo (JP); Yoshiyuki Yajima, Tokyo (JP)

(73) Assignee: NEC Corporation, Tokyo (JP)

(21) Appl. No.: 19/544,052

(22) Filed: Feb. 19, 2026

(30) Foreign Application Priority Data
Mar. 3, 2025 (JP) 2025-032866

(51) Int. Cl. G01D 9/00; G01D 5/26; G08G 1/01; G08G 1/04

(52) U.S. Cl. CPC G01D 9/00; G01D 5/268; G08G 1/0112; G08G 1/0116; G08G 1/04

(57) ABSTRACT

A data integration device according to the present disclosure includes at least one memory configured to store instructions, and at least one processor. The processor is configured to execute the instructions to perform acquiring a vehicle trajectory of a vehicle traveling on a road, the vehicle trajectory being extracted by an optical fiber sensor installed on the road, acquiring vehicle information on a vehicle traveling on the road, the vehicle information being detected by a roadside sensor installed on the road, and associating the vehicle information detected by the roadside sensor with the vehicle trajectory extracted by the optical fiber sensor.

### INCORPORATION BY REFERENCE

This application is based upon and claims the benefit of priority from Japanese patent application No. 2025-032866, filed on March 3, 2025, the disclosure of which is incorporated herein in its entirety by reference.

### TECHNICAL FIELD

The present disclosure relates to a data integration device, a data integration method, and a non-transitory computer-readable medium.

### BACKGROUND ART

Studies for utilizing a digital twin for road traffic are under way. The digital twin is a technique of collecting information of a real space, replicating the collected information on a virtual space, and reproducing an environment of the real space on the virtual space.

If a digital twin of road traffic can be implemented, by simulating an event that can occur on a road on a virtual space and feeding back the result to a real space, it is possible to promote maximization of traffic efficiency in a wide range and avoidance of danger such as a traffic accident in advance.

In order to implement a digital twin of road traffic, it is necessary to collect sensor data of real space from a wide variety of sensors for detecting vehicles on a road. On the other hand, in the virtual space, it is necessary to integrate the sensor data obtained by each sensor in order to interpolate the blind spot region depending on the type of sensor, the installation position, and the like.

However, at present, since the sensors detect vehicles on the road independently of each other, sensor data of the sensors are not synchronized in time and space. Therefore, it is necessary to synchronize the time and space of the sensor data between the sensors.

As a technique for synchronizing the time and space of the sensor data between the sensors, there is a technique disclosed in WO 2021/006262 A. In the technique disclosed in WO 2021/006262 A, sensor data of an external sensor (camera, radar, LiDAR, etc.) mounted on a host vehicle is synchronized with sensor data or the like of an external sensor installed on a road.

### SUMMARY

However, in the technique disclosed in WO 2021/006262 A, the sensors that synchronize the time and space of the sensor data are limited to cameras, radars, Lidars, and the like, and these sensors are not comprehensively installed on roads.

Therefore, the technique disclosed in WO 2021/006262 A cannot acquire comprehensive sensor data of the entire road, and as a result, it is difficult to simulate the entire road in the virtual space.

Therefore, in view of the above-described problems, an example object of the present disclosure is to provide a data integration device, a data integration method, and a non-transitory computer-readable medium that can contribute to simulating the entire road in the virtual space.

A data integration device according to an example aspect includes at least one memory configured to store instructions, and at least one processor.

The processor is configured to execute the instructions to perform acquiring a vehicle trajectory of a vehicle traveling on a road, the vehicle trajectory being extracted by an optical fiber sensor installed on the road;

acquiring vehicle information on a vehicle traveling on the road, the vehicle information being detected by a roadside sensor installed on the road; and

associating the vehicle information detected by the roadside sensor with the vehicle trajectory extracted by the optical fiber sensor.

A data integration method according to an example aspect, executed by a data integration device, includes

acquiring a vehicle trajectory of a vehicle traveling on a road, the vehicle trajectory being extracted by an optical fiber sensor installed on the road;

acquiring vehicle information on a vehicle traveling on the road, the vehicle information being detected by a roadside sensor installed on the road; and

associating the vehicle information detected by the roadside sensor with the vehicle trajectory extracted by the optical fiber sensor.

A non-transitory computer-readable medium according to an example aspect has stored therein a program causing a computer to execute

a procedure for acquiring a vehicle trajectory of a vehicle traveling on a road, the vehicle trajectory being extracted by an optical fiber sensor installed on the road;

a procedure for acquiring vehicle information on a vehicle traveling on the road, the vehicle information being detected by a roadside sensor installed on the road; and

a procedure for associating the vehicle information detected by the roadside sensor with the vehicle trajectory extracted by the optical fiber sensor.

According to the above aspect, it is possible to provide a data integration device, a data integration method, and a non-transitory computer-readable medium that can contribute to simulating the entire road in the virtual space.

### BRIEF DESCRIPTION OF DRAWINGS

The above and other aspects, features and advantages of the present disclosure will become more apparent from the following description of certain exemplary embodiments, taken in conjunction with the accompanying drawings, in which:

FIG. 1 is a diagram for explaining an example of a flow of an operation of integrating sensor data of a plurality of roadside sensors in a related art;

FIG. 2 is a diagram for explaining a specific example of processing in step S102 in FIG. 1;

FIG. 3 is a diagram for explaining a specific example of processing in step S103 in FIG. 1;

FIG. 4 is a diagram for explaining a characteristic example of a representative sensor for detecting a vehicle on a road;

FIG. 5 is a block diagram illustrating a configuration example of a data integration device according to the present disclosure;

FIG. 6 is a diagram for explaining an example of a flow of an operation of integrating sensor data of a plurality of roadside sensors and optical fiber sensors in the data integration device according to the present disclosure;

FIG. 7 is a diagram for explaining a specific example of processing in step S203 in FIG. 6;

FIG. 8 is a diagram for explaining an example of a correct candidate 1 selected from among candidates 1 to 4 in FIG. 3 by the data integration device according to the present disclosure;

FIG. 9 is a block diagram illustrating a configuration example of the data integration device according to the present disclosure;

FIG. 10 is a diagram for explaining an example of a flow of an operation of integrating sensor data of a plurality of roadside sensors, in-vehicle sensors, and optical fiber sensors in the data integration device according to the present disclosure;

FIG. 11 is a diagram for explaining an image example of the operation of the data integration device according to the present disclosure;

FIG. 12 is a diagram for explaining a specific example of processing in step S402 in FIG. 11;

FIG. 13 is a block diagram illustrating a configuration example of the data integration device according to the present disclosure; and

FIG. 14 is a block diagram illustrating a hardware configuration example of a computer that implements the data integration device according to the present disclosure.

### EXAMPLE EMBODIMENT

Hereinafter, example embodiments and the related art of the present disclosure will be described with reference to the diagrams. In the following descriptions and drawings, omission and simplification are made as appropriate for the sake of clarity. In the following drawings, the same elements are denoted by the same reference numerals, and redundant description will be omitted as necessary. Specific numerical values and the like shown below are merely examples for facilitating understanding of the present disclosure, and are not limited thereto.

### Related art

Prior to describing example embodiments of the present disclosure, related techniques studied by the present inventors will be described.

As described above, since the sensors for detecting the vehicles on the road in the real space detect the vehicles on the road independently of each other, the sensor data of the sensors are not synchronized in time and space. Therefore, in order to integrate the sensor data of each sensor, it is necessary to synchronize the time and space of the sensor data between the sensors.

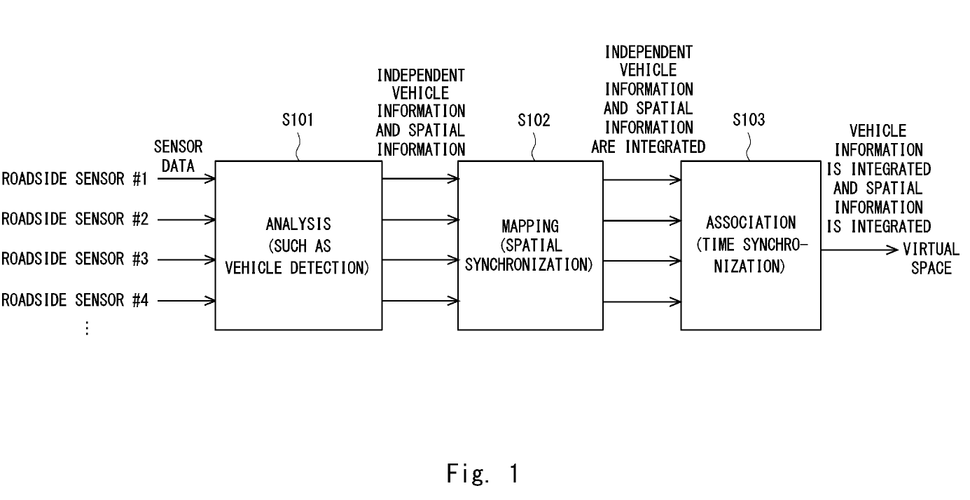

FIG. 1 is a diagram for explaining an example of a flow of an operation of integrating sensor data of a plurality of roadside sensors (#1, #2,...) in a related art.

Here, it is assumed that the roadside sensor is a sensor installed on a road and is a sensor other than an optical fiber sensor described later. For example, the roadside sensor is a camera, a LiDAR, a loop coil, or the like.

As illustrated in FIG. 1, first, sensor data of each of a plurality of roadside sensors is analyzed (step S101). Here, detection of a vehicle or the like is performed.

At this time, the coordinate spaces of the plurality of roadside sensors are different from each other. The vehicles detected by the plurality of roadside sensors are not associated with each other. Therefore, the coordinate information of the coordinate space of each of the plurality of roadside sensors and the vehicle information of the vehicle detected by each of the plurality of roadside sensors are independent of each other.

Therefore, next, mapping is performed to project the coordinate space of each of the plurality of roadside sensors to a uniform coordinate space (step S102). As a result, the coordinate information of each of the plurality of roadside sensors is integrated. On the other hand, the vehicle information of the vehicle detected by each of the plurality of roadside sensors remains independent from each other.

Therefore, next, vehicle information of the vehicle detected by each of the plurality of roadside sensors is associated (step S103). That is, for the same vehicle detected by each of the plurality of roadside sensors, the time axes of the plurality of roadside sensors are aligned. As a result, the vehicle information of the vehicle detected by each of the plurality of roadside sensors is also integrated. By replicating the integrated spatial information and vehicle information on the virtual space, the environment of the real space is reproduced on the virtual space.

However, in a case where there is a blind spot region in a roadside sensor, there is a problem that it is difficult to associate vehicle information of a vehicle detected by each of a plurality of roadside sensors.

Hereinafter, the above-described problems of the related art will be described with specific examples. Here, a camera and a LiDAR are installed as roadside sensors on a road, and sensor data of the camera and the LiDAR are integrated.

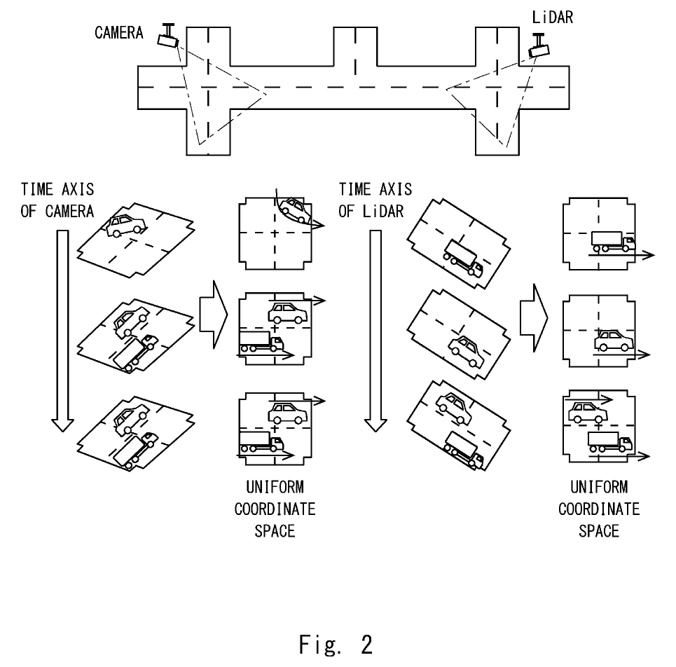

FIG. 2 is a diagram for explaining a specific example of processing in step S102 in FIG. 1.

As illustrated in FIG. 2, the camera and the LiDAR have different coordinate spaces. Therefore, mapping is performed to project the coordinate space of each of the camera and the LiDAR to a uniform coordinate space. As a result, the coordinate information of each of the camera and the LiDAR is integrated. On the other hand, the vehicle information of the vehicle detected by each of the camera and the LiDAR remains independent of each other.

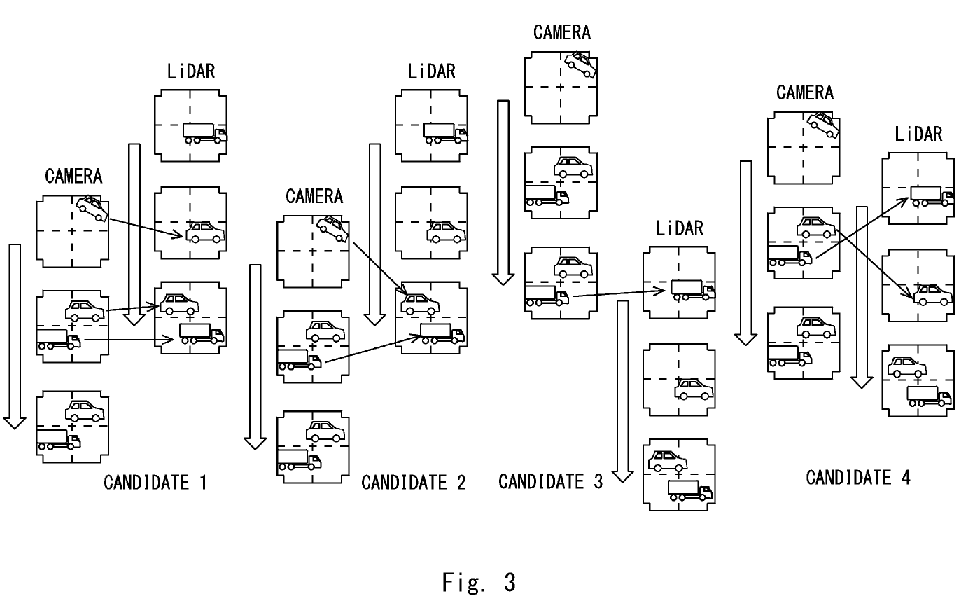

FIG. 3 is a diagram for explaining a specific example of processing in step S103 in FIG. 1.

As illustrated in FIG. 3, even if the coordinate space of each of the camera and the LiDAR can be projected to a uniform coordinate space, the vehicle information of the vehicle detected by each of the camera and the LiDAR is not associated. Therefore, vehicle information of the vehicle detected by each of the camera and the LiDAR is associated. That is, for the same vehicle detected by each of the camera and the LiDAR, the time axis of the camera and the time axis of the LiDAR are aligned.

However, if there is a blind spot region in the camera and the LiDAR, it is difficult to associate the vehicle information of the vehicle detected by each of the camera and the LiDAR, that is, to match the time axis of the camera and the time axis of the LiDAR.

In the example of FIG. 3, four candidates 1 to 4 exist as candidates for association of vehicle information.

Therefore, in the related art, there is a possibility that an erroneous candidate is selected from among the four candidates 1 to 4. If a wrong candidate is selected, the traffic condition of the road cannot be correctly reflected in the virtual space. As a result, it is difficult to perform correct simulation on the virtual space, which makes it difficult to implement a digital twin of road traffic. Association of vehicle information becomes more difficult as the number of roadside sensors increases and the virtual space becomes wider.

In the related art, sensors assumed as roadside sensors are cameras, LiDARs, radars, loop coils, and the like, and none of these sensors is installed comprehensively on a road. Therefore, it is not possible to acquire comprehensive sensor data of the entire road, and as a result, it is difficult to simulate the entire road in the virtual space.

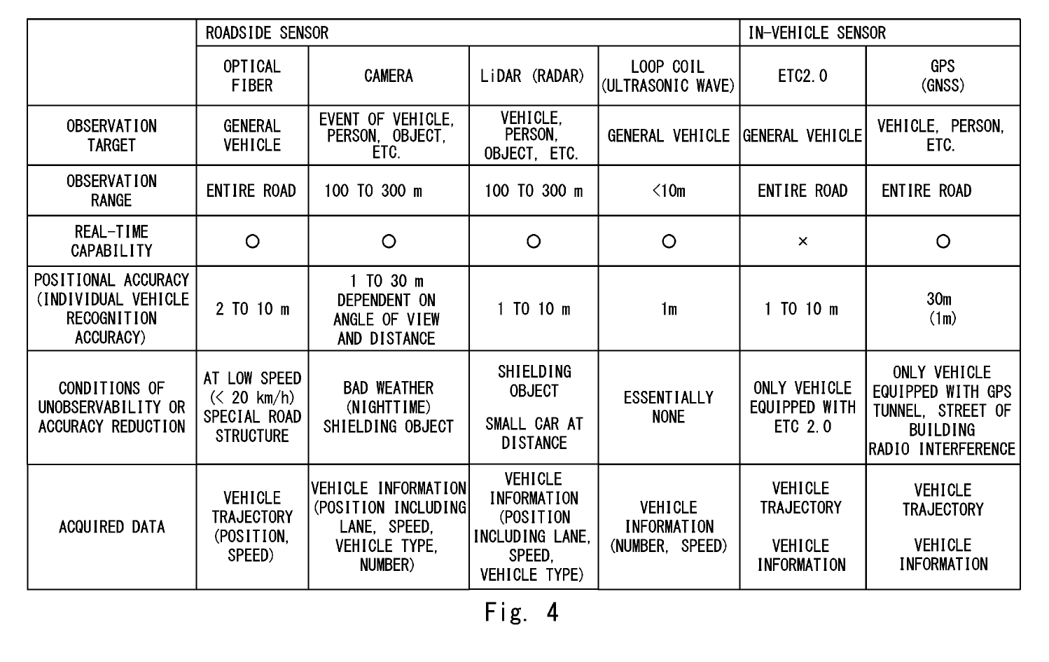

FIG. 4 is a diagram for explaining a characteristic example of a representative sensor for detecting a vehicle on a road. Specific numerical values shown in FIG. 4 are merely examples for facilitating understanding of the present disclosure, and the present disclosure is not limited thereto.

As illustrated in FIG. 4, examples of the roadside sensor include an optical fiber sensor in addition to the above-described camera, LiDAR, and loop coil. The optical fiber sensor is an optical fiber used as a sensor in optical fiber sensing, and is laid along a road. Examples of the in-vehicle sensor include an electronic toll collection system (ETC) 2.0 and a global positioning system (GPS). ETC 2.0 is defined as a sensor in the present specification because it can acquire a travel history of the vehicle based on, for example, GPS information. The GPS is an example of a global navigation satellite system (GNSS).

Here, focusing on the observation range of the roadside sensor, the entire road line is the observation range only for the optical fiber sensor. In optical fiber sensing, existing optical fibers can be used, and in Japan, optical fibers are already laid on expressways and first-class national highways.

Therefore, in a case where the optical fiber sensor is used, it is possible to acquire comprehensive sensor data of the entire road in many roads represented by expressways and first-class national highways.

Therefore, in each example embodiment described below, the sensor data of each sensor is integrated using the sensor data of the optical fiber sensor.

### First Example Embodiment

First, a configuration of a data integration device 10 according to the present disclosure will be described.

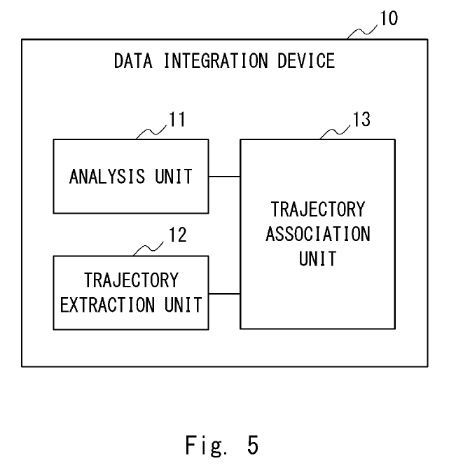

FIG. 5 is a block diagram illustrating a configuration example of the data integration device 10 according to the present disclosure.

As illustrated in FIG. 5, the data integration device 10 includes an analysis unit 11, a trajectory extraction unit 12, and a trajectory association unit 13.

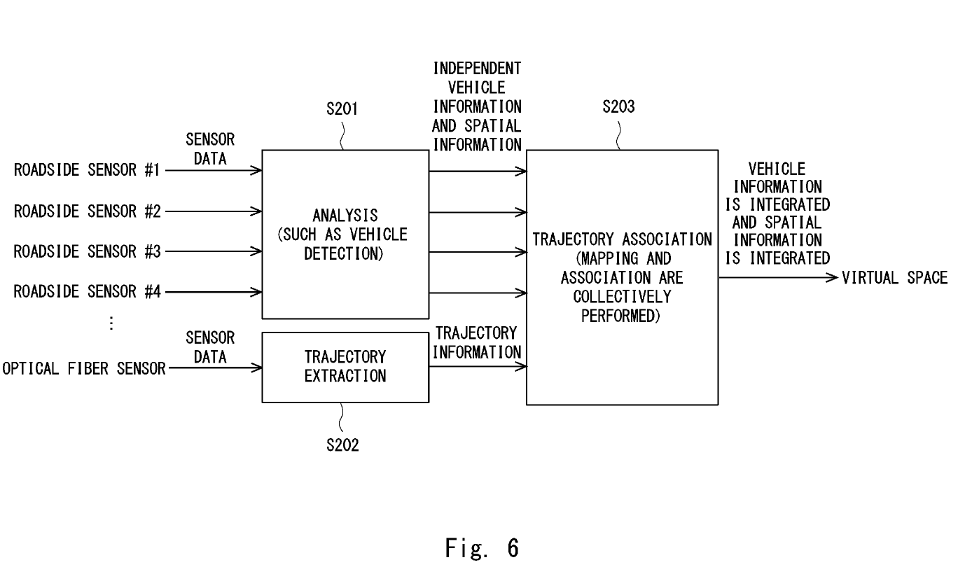

The operations of the analysis unit 11, the trajectory extraction unit 12, and the trajectory association unit 13 will be described below in the description using FIGS. 6 to 8.

Next, an operation of the data integration device 10 according to the present disclosure will be described.

FIG. 6 is a diagram for explaining an example of a flow of an operation of integrating sensor data of a plurality of roadside sensors (#1, #2,...) and an optical fiber sensor in the data integration device 10 according to the present disclosure.

Here, it is assumed that the roadside sensor is similar to the roadside sensor described in FIG. 1. The optical fiber sensor is an optical fiber sensor installed on the same road as the plurality of roadside sensors.

As illustrated in FIG. 6, the analysis unit 11 analyzes sensor data of each of a plurality of roadside sensors (step S201). Here, the analysis unit 11 detects a vehicle and the like. At this time, the coordinate information of the coordinate space of each of the plurality of roadside sensors and the vehicle information of the vehicle detected by each of the plurality of roadside sensors are independent of each other.

The trajectory extraction unit 12 extracts the vehicle trajectory extracted by the optical fiber sensor from the sensor data of the optical fiber sensor (step S202).

Thereafter, the trajectory association unit 13 associates the vehicle information of the vehicle detected by each of the plurality of roadside sensors with the vehicle trajectory extracted by the optical fiber sensor (step S203). The association in step S203 is relevant to collectively performing the mapping and the association in steps S102 and S103 in FIG. 1 in the related art. As a result, the coordinate information and the vehicle information of each of the plurality of roadside sensors and the optical fiber sensors are integrated. By replicating the integrated spatial information and vehicle information on the virtual space, the environment of the real space is reproduced on the virtual space.

Hereinafter, an operation of integrating sensor data in the data integration device 10 according to the present disclosure will be described with a specific example. Here, a camera and a LiDAR are installed as roadside sensors on a road, and an optical fiber sensor is installed, and sensor data of the optical fiber sensor, the camera, and the LiDAR are integrated.

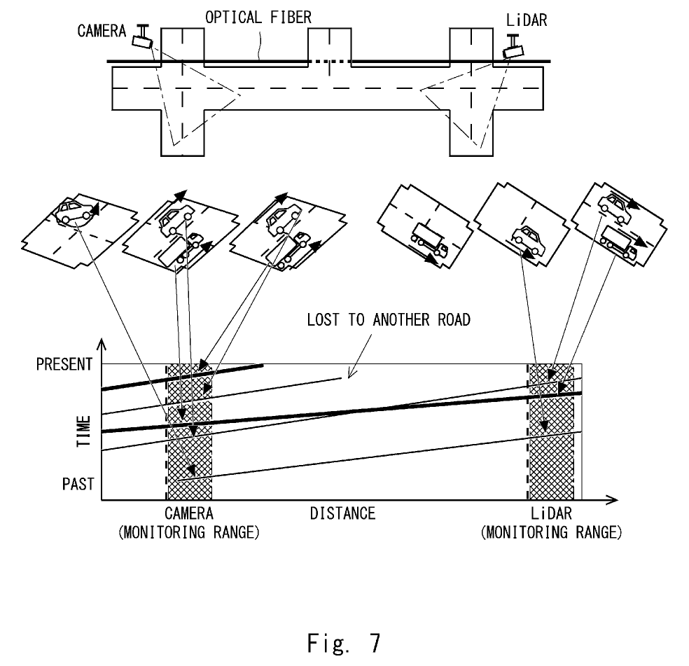

FIG. 7 is a diagram for explaining a specific example of processing in step S203 in FIG. 6.

As illustrated in FIG. 7, in the sensor data of the optical fiber sensor, the horizontal axis indicates the distance of the optical fiber from the sensing device such as distributed acoustic sensing (DAS), and the vertical axis indicates the time lapse of the time in a case where vibration occurs at the distance. The more positive along the vertical axis, the newer the data.

In the sensor data of the optical fiber sensor, that one vehicle is traveling on a road is represented by one line obliquely. An absolute value of the inclination of the line represents the traveling speed of the vehicle, and the smaller the absolute value of the inclination of the line, the higher the traveling speed of the vehicle. The positive and negative inclinations of the line represent traveling directions of the vehicle. The shading of the line represents the vibration intensity, and the darker the line, the higher the vibration intensity.

Therefore, the vehicle trajectory can be extracted by the optical fiber sensor. The trajectory extraction unit 12 extracts an oblique line appearing in the sensor data of the optical fiber sensor as a vehicle trajectory.

The trajectory association unit 13 associates vehicle information of the vehicle detected by each of the camera and the LiDAR with the vehicle trajectory extracted by the optical fiber sensor.

Specifically, in the example of FIG. 7, since there are five oblique lines in the monitoring range of the camera, trajectories of five vehicles are extracted by the optical fiber sensor. Therefore, the trajectory association unit 13 associates the five vehicles detected by the camera with the trajectories of the five vehicles extracted by the optical fiber sensor.

Since there are three oblique lines in the monitoring range of the LiDAR, trajectories of three vehicles are extracted by the optical fiber sensor. Therefore, the trajectory association unit 13 associates three of the four vehicles detected by the LiDAR with the trajectories of the three vehicles extracted by the optical fiber sensor. At this time, it is considered that the remaining one of the four vehicles detected by the LiDAR has been traveling on another road.

As described above, according to the first example embodiment, the vehicle information of the vehicle detected by each of the camera and the LiDAR is associated with the vehicle trajectory extracted by the optical fiber sensor. This automatically achieves spatiotemporal synchronization of the sensor data of the optical fiber sensor, the camera, and the LiDAR.

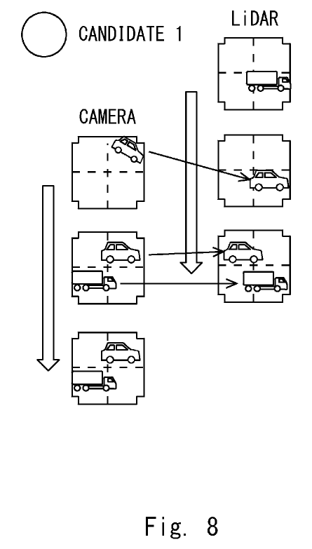

According to the first example embodiment, it is possible to correctly associate the vehicle information between the camera and the LiDAR with which it is difficult to associate the vehicle information in the related art. In the example of FIG. 3, four candidates 1 to 4 exist as candidates for association of vehicle information. According to the first example embodiment, as illustrated in FIG. 8, it is possible to select a correct candidate 1 from among the four candidates 1 to 4 in FIG. 3 and correctly associate the vehicle information. As a result, it is possible to grasp the behavior of the vehicle in the blind spot regions of the camera and the LiDAR.

As described above, according to the first example embodiment, the data integration device 10 associates the vehicle information of the vehicle detected by each of the plurality of roadside sensors with the vehicle trajectory extracted by the optical fiber sensor. Since the optical fiber sensor can acquire comprehensive sensor data of the entire road, the optical fiber sensor can contribute to simulating the entire road in the virtual space. The vehicle information of the vehicle detected by each of the plurality of roadside sensors can be correctly associated among the plurality of roadside sensors, which can contribute to correct simulation of the entire road in the virtual space. This can contribute to the implementation of a digital twin of road traffic.

By feeding back the simulation result on the virtual space to the real space, it is possible to track the illegal vehicle and the dangerous vehicle. For example, it is possible to track a wrong-way-driving vehicle, an overloaded vehicle, or the like detected by a camera or the like without losing sight thereof.

By feeding back the simulation result on the virtual space to the real space, it is possible to support merging of vehicles on expressways or the like. For example, it is possible to support the entry of the vehicle from the interchange to the merging portion while grasping the vehicle length of the vehicle entering the merging portion from the interchange, the vehicle length of the vehicle on the main line approaching the merging portion, and the like with a camera or the like. At this time, the vehicle on the main line may be urged to adjust the inter-vehicle distance or change the lane to the overtaking lane. Such information may be provided to the self-driving vehicle entering the merging portion from the interchange and used as look-ahead information.

### Second Example Embodiment

First, a configuration of a data integration device 10A according to the present disclosure will be described.

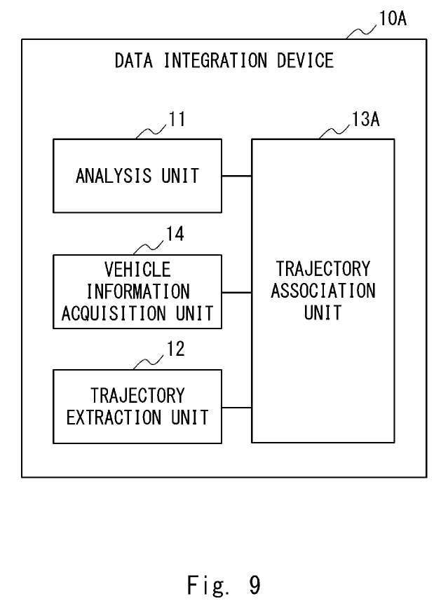

FIG. 9 is a block diagram illustrating a configuration example of the data integration device 10A according to the present disclosure.

As illustrated in FIG. 9, the data integration device 10A includes an analysis unit 11, a trajectory extraction unit 12, a vehicle information acquisition unit 14, and a trajectory association unit 13A. That is, the data integration device 10A is different from the data integration device 10 illustrated in FIG. 5 in that the vehicle information acquisition unit 14 is added and that the trajectory association unit 13 is replaced with the trajectory association unit 13A.

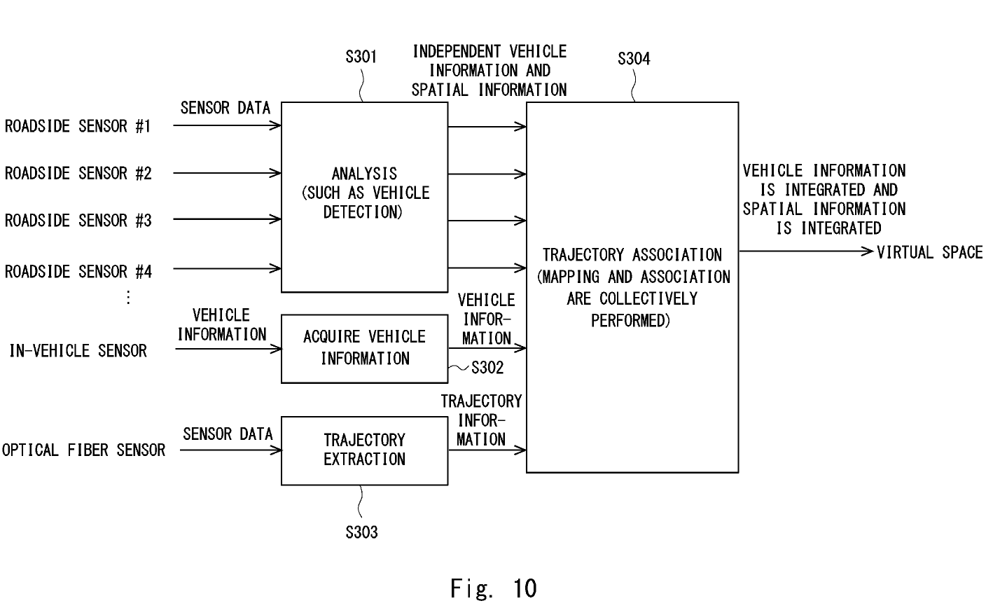

The operations of the analysis unit 11, the trajectory extraction unit 12, the vehicle information acquisition unit 14, and the trajectory association unit 13A will be described in the following description with reference to FIG. 10.

Next, an operation of the data integration device 10A according to the present disclosure will be described.

FIG. 10 is a diagram for explaining an example of a flow of an operation of integrating sensor data of a plurality of roadside sensors (#1, #2,...), an in-vehicle sensor, and an optical fiber sensor in the data integration device 10A according to the present disclosure.

Here, the roadside sensor and the optical fiber sensor are similar to the roadside sensor and the optical fiber sensor described in FIG. 6. The in-vehicle sensor is an in-vehicle sensor mounted on a vehicle traveling on a road on which a plurality of roadside sensors and an optical fiber sensor are installed. For example, the in-vehicle sensor is ETC 2.0, GPS, or the like.

As illustrated in FIG. 10, the analysis unit 11 analyzes sensor data of each of a plurality of roadside sensors (step S301). Here, the analysis unit 11 detects a vehicle and the like. At this time, the coordinate information of the coordinate space of each of the plurality of roadside sensors and the vehicle information of the vehicle detected by each of the plurality of roadside sensors are independent of each other.

The vehicle information acquisition unit 14 acquires vehicle information of the vehicle from an in-vehicle sensor mounted on the vehicle (step S302). For example, the vehicle information acquired by the vehicle information acquisition unit 14 is a type, a color, a size (vehicle length, vehicle width, height, and the like), a travel history, and the like of the vehicle.

The trajectory extraction unit 12 extracts the vehicle trajectory extracted by the optical fiber sensor from the sensor data of the optical fiber sensor (step S303).

Thereafter, the trajectory association unit 13A associates the vehicle information of the vehicle detected by each of the plurality of roadside sensors and the vehicle information acquired from the in-vehicle sensor with the vehicle trajectory extracted by the optical fiber sensor (step S404). As a result, the coordinate information and the vehicle information of each of the plurality of roadside sensors, the in-vehicle sensor, and the optical fiber sensor are integrated. By replicating the integrated spatial information and vehicle information on the virtual space, the environment of the real space is reproduced on the virtual space.

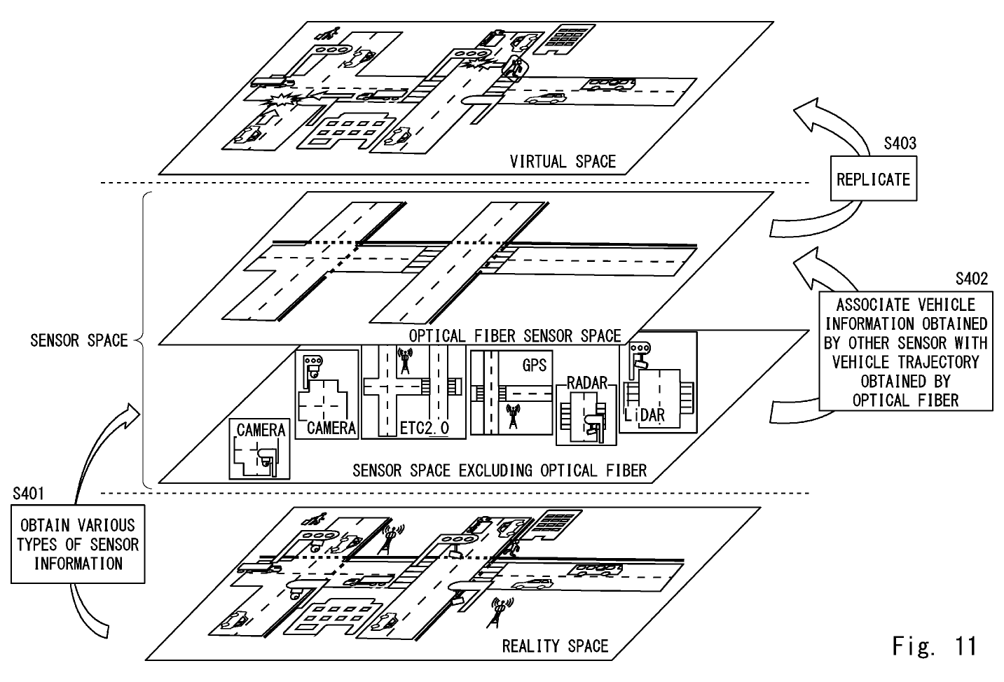

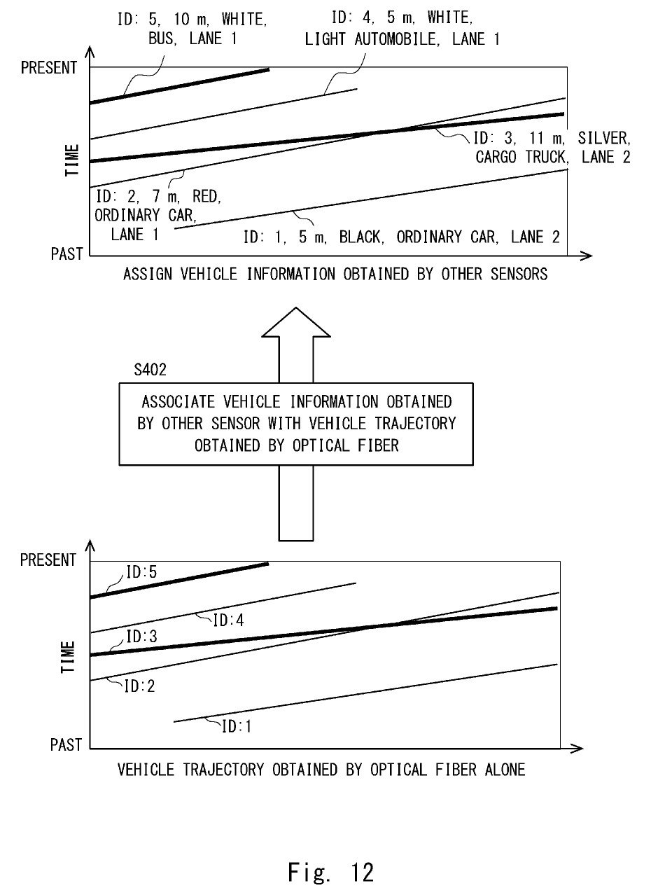

FIG. 11 is a diagram for explaining an image example of the operation of the data integration device 10A according to the present disclosure. FIG. 12 is a diagram for explaining a specific example of processing in step S402 in FIG. 11.

As illustrated in FIG. 11, first, information of each of a plurality of roadside sensors, an in-vehicle sensor, and an optical fiber sensor is acquired in real space (step S401). At this time, sensor spaces of the plurality of roadside sensors, the in-vehicle sensor, and the optical fiber sensor are independent from each other.

Next, the vehicle trajectory obtained by the optical fiber sensor is associated with vehicle information obtained by sensors (the plurality of roadside sensors and the in-vehicle sensor) other than the optical fiber sensor (step S402). As a result, the sensor spaces of the other sensors are integrated into the sensor space of the optical fiber sensor.

For example, as illustrated in FIG. 12, only a vehicle identity (ID) is assigned to a vehicle trajectory obtained by an optical fiber sensor alone. Vehicle information obtained by the other sensors is associated with the vehicle trajectory. As a result, in the example of FIG. 12, vehicle information of the vehicle length, color, vehicle type, and traveling lane is assigned to the vehicle trajectory in addition to the vehicle ID.

Thereafter, information of the sensor space of the optical fiber sensor in which the sensor spaces of the other sensors are integrated is replicated on the virtual space (step S403). As a result, the environment of the real space is reproduced on the virtual space.

As described above, according to the second example embodiment, the data integration device 10A associates the vehicle information of the vehicle detected by each of the plurality of roadside sensors and the vehicle information acquired from the in-vehicle sensor with the vehicle trajectory extracted by the optical fiber sensor. As a result, more detailed vehicle information can be associated with the vehicle trajectory as compared with the first example embodiment described above.

The other effects are similar to the effects according to the first example embodiment described above.

### Third Example Embodiment

The third example embodiment is associated with an example embodiment that generalizes the first and second example embodiments described above.

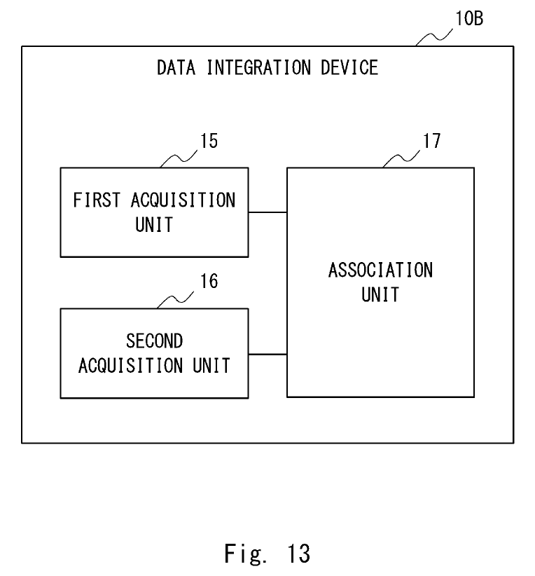

FIG. 13 is a block diagram illustrating a configuration example of a data integration device 10B according to the present disclosure.

As illustrated in FIG. 13, the data integration device 10B includes a first acquisition unit 15, a second acquisition unit 16, and an association unit 17.

The first acquisition unit 15 acquires a vehicle trajectory traveling on a road extracted by an optical fiber sensor installed on the road.

The second acquisition unit 16 acquires information on a vehicle traveling on a road detected by a roadside sensor installed on the road.

The association unit 17 associates vehicle information detected by the roadside sensor with the vehicle trajectory extracted by the optical fiber sensor.

Here, the optical fiber sensor can acquire comprehensive sensor data of the entire road. Therefore, it can contribute to simulating the entire road in the virtual space.

The second acquisition unit 16 may acquire information on a vehicle traveling on a road detected by each of a plurality of roadside sensors installed on the road. The association unit 17 may associate vehicle information detected by each of the plurality of roadside sensors with the vehicle trajectory extracted by the optical fiber sensor.

The association unit 17 may associate the vehicle information detected by the roadside sensor with a trajectory within a monitoring range of the roadside sensor among vehicle trajectories extracted by the optical fiber sensor for each of the plurality of roadside sensors.

The second acquisition unit 16 may acquire information on a vehicle traveling on a road from an in-vehicle sensor mounted on the vehicle. The association unit 17 may associate the vehicle information acquired from the in-vehicle sensor with the vehicle trajectory extracted by the optical fiber sensor.

### Other Example Embodiments

In the first, second, and third example embodiments described above, a plurality of components are provided in the data integration devices 10, 10A, and 10B, but the present disclosure is not limited thereto. In the present disclosure, the plurality of components may be provided in a plurality of devices in a distributed manner. That is, the present disclosure may be achieved by a system including a plurality of devices.

### Hardware Configuration of Data Integration Device according to Present Disclosure

Next, a hardware configuration of a computer that implements the data integration devices 10, 10A, and 10B according to the present disclosure will be described.

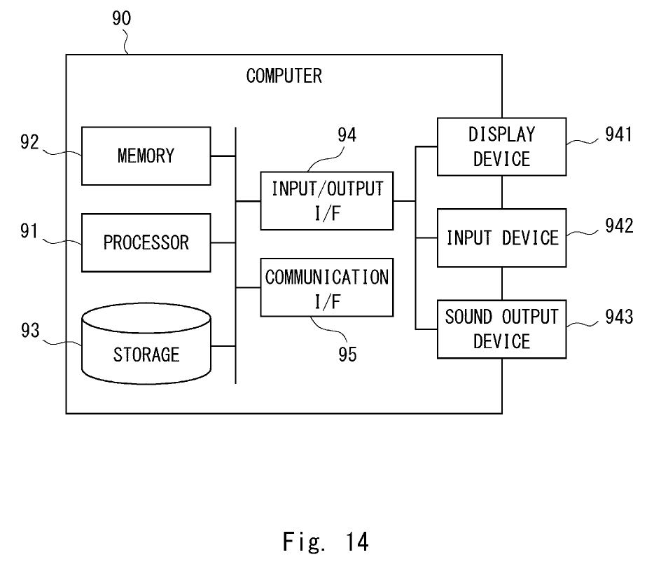

FIG. 14 is a block diagram illustrating a hardware configuration example of a computer 90 that implements the data integration devices 10, 10A, and 10B according to the present disclosure.

As illustrated in FIG. 14, the computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected by a data transmission path for mutually transmitting and receiving data.

The processor 91 is, for example, an arithmetic processing device such as a Central Processing Unit (CPU) or a Graphics Processing Unit (GPU). The memory 92 is, for example, a memory such as a Random Access Memory (RAM) or a Read Only Memory (ROM). The storage 93 is, for example, a storage device such as a Hard Disk Drive (HDD), a Solid State Drive (SSD), or a memory card. The storage 93 may be a memory such as the RAM or the ROM.

A program is stored in the storage 93. This program includes instructions (or software code) for causing the computer 90 to perform one or more functions of the data integration devices 10, 10A, and 10B described above in a case where the program is read by the computer. The components in the data integration devices 10,10A, and 10B described above may be implemented by the processor 91 reading and executing a program stored in the storage 93. The storage function in the data integration devices 10,10A, and 10B described above may be implemented by the memory 92 or the storage 93.

Further, the above-described program may be stored in a non-transitory computer-readable medium or a tangible storage medium. As an example and not by way of limitation, the computer-readable medium or the tangible storage medium includes a RAM, a ROM, a flash memory, an SSD or another memory technology, a compact disc (CD)-ROM, a digital versatile disc (DVD), a Blu-ray (registered trademark) disk or another optical disk storage, a magnetic cassette, a magnetic tape, a magnetic disk storage, or another magnetic storage device. The program may be transmitted on a transitory computer-readable medium or a communication medium. As an example and not by way of limitation, the transitory computer-readable medium or the communication medium includes an electrical signal, an optical signal, an acoustic signal, or another form of propagation signal.

The input/output interface 94 is connected to a display device 941, an input device 942, a sound output device 943, and the like. The display device 941 is a device that displays a screen relevant to drawing data processed by the processor 91, such as a Liquid Crystal Display (LCD), a Cathode Ray Tube (CRT) display, or a monitor. The input device 942 is a device that receives operator’s operation input, and is, for example, a keyboard, a mouse, a touch sensor, or the like. The display device 941 and the input device 942 may be integrated and implemented as a touch panel. The sound output device 943 is a device that acoustically outputs a sound relevant to acoustic data processed by the processor 91, such as a speaker.

The communication interface 95 transmits and receives data to and from an external device. For example, the communication interface 95 communicates with an external device via a wired communication path or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Further, each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### Supplementary Note 1

A data integration device including:

at least one memory configured to store instructions; and

at least one processor configured to execute the instructions to perform:

acquiring a vehicle trajectory of a vehicle traveling on a road, the vehicle trajectory being extracted by an optical fiber sensor installed on the road;

acquiring vehicle information on a vehicle traveling on the road, the vehicle information being detected by a roadside sensor installed on the road; and

associating the vehicle information detected by the roadside sensor with the vehicle trajectory extracted by the optical fiber sensor.

### Supplementary Note 2

The data integration device according to Supplementary Note 1, in which the at least one processor is configured to execute the instructions to perform:

acquiring the vehicle information on the vehicle traveling on the road, the vehicle information being detected by each of a plurality of the roadside sensors installed on the road; and

associating the vehicle information detected by each of a plurality of the roadside sensors with the vehicle trajectory extracted by the optical fiber sensor.

### Supplementary Note 3

The data integration device according to Supplementary Note 2, in which the at least one processor is configured to execute the instructions to perform associating, for each of the plurality of roadside sensors, the vehicle information detected by the roadside sensor with the vehicle trajectory within a monitoring range of the roadside sensor among vehicle trajectories extracted by the optical fiber sensor.

### Supplementary Note 4

The data integration device according to Supplementary Note 1, in which the at least one processor is configured to execute the instructions to perform:

acquiring the vehicle information on the vehicle from an in-vehicle sensor mounted on the vehicle traveling on the road; and

associating the vehicle information acquired from the in-vehicle sensor with the vehicle trajectory extracted by the optical fiber sensor.

### Supplementary Note 5

A data integration method executed by a data integration device, including:

acquiring a vehicle trajectory of a vehicle traveling on a road, the vehicle trajectory being extracted by an optical fiber sensor installed on the road;

acquiring vehicle information on a vehicle traveling on the road, the vehicle information being detected by a roadside sensor installed on the road; and

associating the vehicle information detected by the roadside sensor with the vehicle trajectory extracted by the optical fiber sensor.

### Supplementary Note 6

A non-transitory computer-readable medium having stored therein a program causing a computer to execute:

a procedure for acquiring a vehicle trajectory of a vehicle traveling on a road, the vehicle trajectory being extracted by an optical fiber sensor installed on the road;

a procedure for acquiring vehicle information on a vehicle traveling on the road, the vehicle information being detected by a roadside sensor installed on the road; and

a procedure for associating the vehicle information detected by the roadside sensor with the vehicle trajectory extracted by the optical fiber sensor.

Note that, some or all of elements (e.g., structures and functions) specified in Supplementary Notes 2 to 4 dependent on Supplementary Note 1 may also be dependent on Supplementary Note 5 and Supplementary Note 6 in dependency similar to that of Supplementary Notes 2 to 4 dependent on Supplementary Note 1. Some or all of elements specified in any of Supplementary Notes may be applied to various types of hardware, software, and recording means for recording software, systems, and methods.

What is claimed is:

1. A data integration device comprising:
at least one memory configured to store instructions; and
at least one processor configured to execute the instructions to perform:
acquiring a vehicle trajectory of a vehicle traveling on a road, the vehicle trajectory being extracted by an optical fiber sensor installed on the road;
acquiring vehicle information on a vehicle traveling on the road, the vehicle information being detected by a roadside sensor installed on the road; and
associating the vehicle information detected by the roadside sensor with the vehicle trajectory extracted by the optical fiber sensor.

2. The data integration device according to claim 1, wherein the at least one processor is configured to execute the instructions to perform:
acquiring the vehicle information on the vehicle traveling on the road, the vehicle information being detected by each of a plurality of the roadside sensors installed on the road; and
associating the vehicle information detected by each of a plurality of the roadside sensors with the vehicle trajectory extracted by the optical fiber sensor.

3. The data integration device according to claim 2, wherein the at least one processor is configured to execute the instructions to perform associating, for each of the plurality of roadside sensors, the vehicle information detected by the roadside sensor with the vehicle trajectory within a monitoring range of the roadside sensor among vehicle trajectories extracted by the optical fiber sensor.

4. The data integration device according to claim 1, wherein the at least one processor is configured to execute the instructions to perform:
acquiring the vehicle information on the vehicle from an in-vehicle sensor mounted on the vehicle traveling on the road; and
associating the vehicle information acquired from the in-vehicle sensor with the vehicle trajectory extracted by the optical fiber sensor.

5. A data integration method executed by a data integration device, comprising:
acquiring a vehicle trajectory of a vehicle traveling on a road, the vehicle trajectory being extracted by an optical fiber sensor installed on the road;
acquiring vehicle information on a vehicle traveling on the road, the vehicle information being detected by a roadside sensor installed on the road; and
associating the vehicle information detected by the roadside sensor with the vehicle trajectory extracted by the optical fiber sensor.

6. A non-transitory computer-readable medium having stored therein a program causing a computer to execute:
a procedure for acquiring a vehicle trajectory of a vehicle traveling on a road, the vehicle trajectory being extracted by an optical fiber sensor installed on the road;
a procedure for acquiring vehicle information on a vehicle traveling on the road, the vehicle information being detected by a roadside sensor installed on the road; and
a procedure for associating the vehicle information detected by the roadside sensor with the vehicle trajectory extracted by the optical fiber sensor.
